(19) United States
(12) Patent Application Publication
(10) Pub. No.: US 2009/0066791 A1
(43) Pub. Date: Mar. 12, 2009

(54) Monitoring system

(75) Inventors: Koichi Ono, Kanagawa (JP); Takanobu Ujisato, Tokyo (JP); Shoji Tadano, Kanagawa (JP); Masaaki Kurebayashi, Shizuoka (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/231,948

(22) Filed: Sep. 8, 2008

(30) Foreign Application Priority Data
Sep. 11, 2007 (JP) P2007-235018

(51) Int. Cl. H04N 7/18; H04N 5/33

(52) U.S. Cl. 348/143; 348/164; 348/E07.085; 348/E05.09

(57) ABSTRACT

Disclosed herein is a monitoring system, including an infrared camera; an image pickup direction control section configured to vary the image pickup direction of the infrared camera; a correction section configured to correct irregularity in brightness of a screen image of image data picked up in each of the image pickup directions by the infrared camera and output the corrected image data whose irregularity in brightness is corrected; an image processing section configured to connect the corrected image data corresponding to the image data picked upon in the individual image pickup directions by the infrared camera to produce a whole image; and a display section configured to display the whole image.

referred to sometimes as whole image) produced by connection of a large number of still images can have a very high resolution. Accordingly, when an enlarged image of part of a whole image is obtained, the enlarged image itself has a high resolution and is a distinct image.

While an ordinary video camera is used in the daytime, an infrared camera also called thermal imager and IR camera is used for monitoring at night.

### SUMMARY OF THE INVENTION

Since an infrared camera detects a heat source, all heat sources disposed on the image pickup object side with respect to the video camera have an influence on the image pickup output, and therefore, much distortion occurs when compared with a video camera. One of distortion factors of picked up images by a video camera is, for example, lens distortion. On the other hand, with an infrared camera, an influence of heat generation of a lens barrel as well as lens distortion, an influence of heat generation of the entire camera including a lens retaining section and so forth make factors of distortion of a picked up image.

One of types of distortion is, for example, such screen image irregularity called shading 1a as seen in FIG. 1A by which the luminance of a picked up image 1 on the screen decreases as the distance from the center of the picked up image 1 increases. It is difficult to eliminate the shading la through optical designing or mechanical designing, and this gives rise to a problem that the production cost for lenses and so forth increases significantly for reduction of the shading 1a.

Further, the picked up image 1 with which the shading 1a occurs exhibits little reduction of the luminance at a central portion of the image. Generally, since the image pickup object is in most cases positioned at a central portion of an image, distortion at peripheral portions is less likely to become a significant problem. However, with a monitoring system wherein a plurality of still images are connected to obtain a whole image 2 of a wide field of view, there is a problem that the shading 1a stands out at a boundary portion between adjacent images as seen in FIG. 1B.

Therefore, it is demanded to provide a monitoring system wherein irregularity of an image can be corrected.

According to the embodiment of the present invention, a correction process for uniformizing the in-plane brightness of a picked up image is carried out to obtain an image having little irregularity.

According to an embodiment of the present invention, there is provided a monitoring system, including an infrared camera, an image pickup direction control section configured to vary the image pickup direction of the infrared camera, a correction section configured to correct irregularity in brightness of a screen image of image data picked up in each of the image pickup directions by the infrared camera and output the corrected image data whose irregularity in brightness is corrected, an image processing section configured to connect the corrected image data corresponding to the image data picked upon in the individual image pickup directions by the infrared camera to produce a whole image, and a display section configured to display the whole image, the correction section including a correction value storage section configured to store correction values corresponding to the pixels of the image data, and a subtraction section configured to subtract the correction values read out from the correction value storage section from the pixel values of the pixels of the image data to obtain correction image data and output the correction image data.

According to another embodiment of the present, there is provided a monitoring system, including a video camera, an image pickup direction control section configured to vary the image pickup direction of the video camera, a correction section configured to correct irregularity in brightness of a screen image of image data picked up in each of the image pickup directions by the video camera and output the corrected image data whose irregularity in brightness is corrected, an image processing section configured to connect the corrected image data corresponding to the image data picked upon in the individual image pickup directions by the video camera to produce a whole image, and a display section configured to display the whole image, the correction section including a correction value storage section configured to store correction values corresponding to the pixels of the image data, and a subtraction section configured to subtract the correction values read out from the correction value storage section from the pixel values of the pixels of the image data to obtain correction image data and output the correction image data.

With the monitoring systems, a picked up image having no or little irregularity can be obtained, and the quality of a whole image formed by connecting a plurality of picked up images to each other can be improved.

The above and other objects, features and advantages of the embodiment of the present invention will become apparent from the following description and the appended claims, taken in conjunction with the accompanying drawings in which like parts or elements denoted by like reference symbols.

### BRIEF DESCRIPTION OF THE DRAWINGS

FIGS. 1A and 1B are schematic views illustrating a problem of a picked up image picked up by an existing image pickup apparatus;

FIG. 2 is a block diagram showing an example of a configuration of a monitoring system to which the embodiment of the present invention is applied;

FIG. 3 is a schematic view illustrating an example of whole image production operation in the monitoring system of FIG. 2;

FIG. 4 is a block diagram showing an example of a configuration of an infrared camera and a face correction circuit of the monitoring system of FIG. 2;

FIG. 5 is a block diagram showing an example of a configuration of the face correction circuit shown in FIG. 4;

FIGS. 6, 7 and 8 are views illustrating an example of operation of the face correction circuit shown in FIG. 5; and

FIG. 9 is a block diagram showing another example of a configuration of a monitoring system which uses an image pickup apparatus to which the embodiment of the present invention is applied.

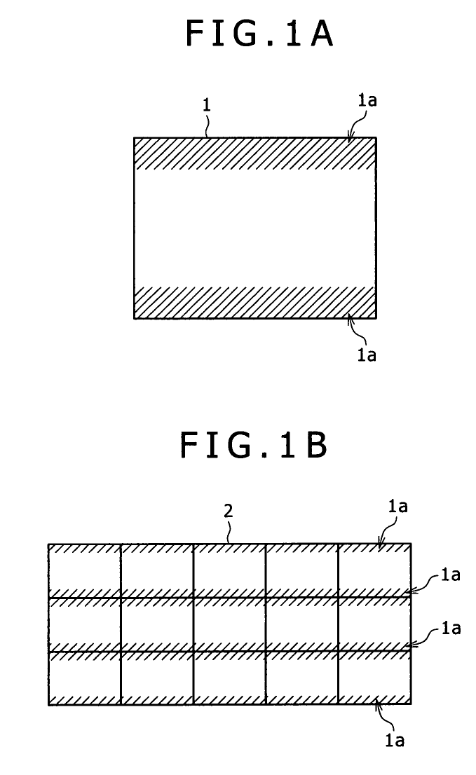

### DETAILED DESCRIPTION OF THE PREFERRED EMBODIMENTS

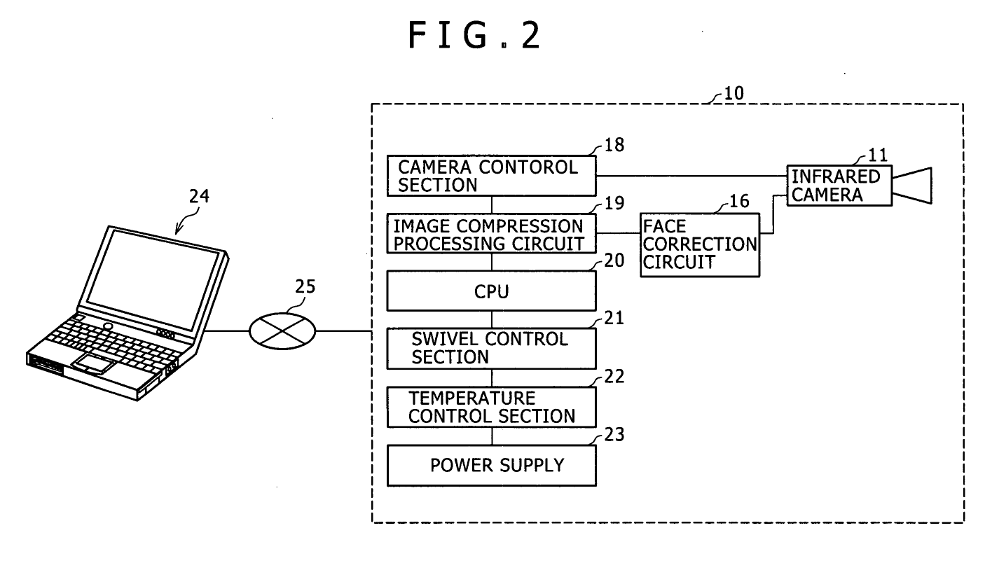

Referring to FIG. 2, there is shown a general configuration of a monitoring system to which the embodiment of the present invention is applied. The monitoring system shown includes a camera unit 10 which in turn includes an infrared camera 11 and a face correction circuit 16 for correcting image data obtained from the infrared camera 11. The camera unit 10 is installed, for example, on the roof of a building and accommodated in a case for outdoor use. The infrared camera 11 of the camera unit 10 includes a telephoto lens and can pick up an image of an image pickup object positioned at a remote place. The infrared camera 11 can be rotated, for example, over 270° in a horizontal direction or panning direction and over 30° in a vertical direction or tilting direction by a panning section and a tilting section for a swivel base not shown, respectively. The panning section and the tilting section include a stepping motor as a driving source thereof.

In the embodiment of the present invention, also a video camera which takes charge principally of image pickup in the daytime is provided although it is omitted for simplified illustration. Monitoring in the daytime and at night can be carried out by both of the infrared camera 11 and the video camera, respectively.

The camera unit 10 is connected to a control apparatus 24 by a network 25 such as a wire LAN (Local Area Network). The control apparatus 24 is configured, for example, from a personal computer, application software and so forth. The control apparatus 24 supplies a control signal to the panning section and the tilting section of the camera unit 10 so that the angle of view of the infrared camera 11 is controlled in accordance with the control signal.

Every time the pickup image center is moved by an angle of view by the panning section and the tilting section, the shutter button is turned on so that a still image is picked up by the camera unit 10. In particular, X still images, for example, 8 still images, are picked up in the vertical direction and N still images, for example, 16 still images, are picked up in the horizontal direction. Consequently, totaling M×N still images, for example, 8×16 still images, are picked up successively. Then, the camera unit 10 corrects and compresses the picked up still images and outputs the image data compressed, for example, in accordance with the JPEG system and image pickup data (hereinafter referred to suitably as metadata) relating to the image data to the control apparatus 24. A display section is provided on the control apparatus 24, and M×N still images obtained by image pickup in different image pickup directions by the infrared camera 11 are displayed in a combined form on the display section to obtain a whole image of a wide field of view. Such a whole image as just mentioned may be hereinafter referred to suitably as panorama image.

Each still image has pixels conforming, for example, to the VGA (Video Graphics Array, 640×480 pixels). In this instance, from 128 still images, a whole image of approximately 40,000,000 pixels including 640×16=10,240 pixels in the vertical direction and 480×8=3,840 pixels ignoring overlapping portions can be formed. Actually, since the display section of the personal computer is used as the display section, the pixel number of the whole image decreases in response to the number of pixels of the display section.

The camera unit 10 includes an infrared camera 11, a face correction circuit 16, a camera control section 18, an image compression processing circuit 19, a central processing unit CPU 20, a swivel control section 21, a temperature control section 22 and a power supply 23.

The infrared camera 11 detects infrared energy emitted from an object solid body, converts the infrared energy into a temperature and displays a distribution of the temperature as an image. The picked up image of the infrared camera 11 is a monochromatic image whose whiteness increases as the temperature rises.

The infrared camera 11 includes, for example, a GPS (Global Positioning System) function for detecting the position of the infrared camera 11 itself. Since the infrared camera 11 includes the GPS function, data of the location of the infrared camera 11 can be recorded and the direction of the infrared camera 11 can be detected. The direction of the infrared camera 11 can be detected from rotational angles of the panning section and the tilting section as well as by means of the GPS function.

The face correction circuit 16 corrects image data inputted from the infrared camera 11, removes irregularity of the brightness or luminance of the image data arising from the infrared camera 11 and outputs resulting uniform image data of the picked up images.

The camera control section 18 notifies the infrared camera 11 and the face correction circuit 16 of image pickup condition setting set by the control apparatus 24. The set image pickup condition may include conditions of the gain, contrast and lens aperture.

The image compression processing circuit 19 carries out a compression coding process, for example, of the JPEG system and a reduction process for corrected image data inputted from the face correction circuit 16 so that the image data may become suitable for outputting to the control apparatus 24.

A CPU 20 controls the panning section and the tilting section through the swivel control section 21 to swivel the infrared camera 11 along a predetermined trajectory to acquire image data. Further, the CPU 20 controls a fan and so forth through the temperature control section 22 so that, for example, the temperature in the case of the infrared camera 11 may become an appropriate temperature. As described hereinabove, in the infrared camera 11, heat generation of the lens barrel or the camera body makes a cause of distortion of a picked up image. Therefore, it is necessary to control the infrared camera 11 so that the temperature of the infrared camera 11 may not have an influence on the picked up image.

The CPU 20 is connected to the control apparatus 24 and carries out control of the components of the camera unit 10 corresponding to a control operation inputted through the control apparatus 24. Further, the CPU 20 controls the image compression processing circuit 19 to output the compressed image data and metadata produced by the image compression processing circuit 19 to the control apparatus 24.

The control apparatus 24 includes, for example, a memory section for storing corrected and compressed image data inputted from the camera unit 10, a display section for displaying a whole image on a screen, a communication section for carrying out communication with the camera unit 10, and so forth. The control apparatus 24 receives the image data and metadata from the camera unit 10 through a network, processes a plurality of corrected and compressed image data and displays a whole image in the form of a panorama image. The whole image in the form of a panorama image is formed from images picked up at different image pickup positions by the camera unit 10 and connected to each other.

By confirming the displayed whole image, monitoring can be carried out. Further, abnormality in a monitoring object region such as, for example, invasion is automatically detected from a temporal variation of the whole image to generate an alarm. The display section of the control apparatus 24 includes, in addition to the whole image display portion, an enlarged image display portion for displaying an enlarged image of a predetermined portion designated by the user, an operation icon portion for operating the camera unit 10, a character information display portion for representing monitoring object information such as an installation location of the camera and so forth.

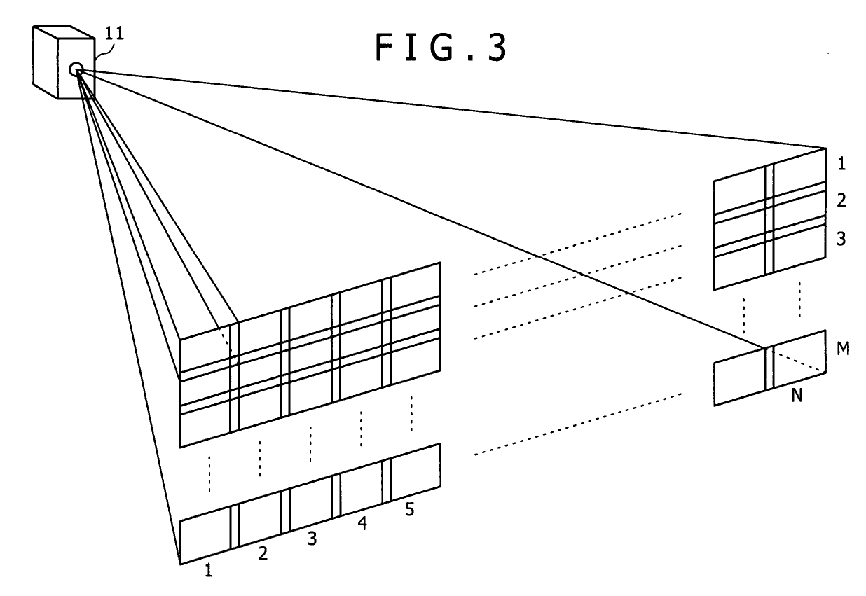

FIG. 3 illustrates operation of picking up an image of a predetermined region by a panning operation and a tilting operation of the infrared camera 11. The infrared camera 11 is installed on the swivel base such that the image pickup direction of the infrared camera 11 is varied from the home position of the infrared camera 11. In FIG. 3, picked up M×N frames are numbered such that the numbers 1, 2, . . . , M are applied in order from above to individual rows and the numbers 1, 2, . . . , N are applied in order from the left to individual columns as viewed from the camera section side in FIG. 3. The home position is a position at which an image for the frame of, for example, the coordinates (M, N)=(1, 1) is picked up.

If an image for the frame at the coordinate position of (1, 1) is picked up, then the infrared camera 11 is panned, and an image for the frame of the next coordinate position of (1, 2) is picked up. Thereafter, images of the frames at the coordinate positions of (1, 3), . . . , (1, N) are picked up, and then an image for the frame of the coordinate position of (2, N) of the second row. Then, images for the frames of the coordinate positions of the (2, N-1), . . . , (2, 1) are picked up. Thereafter, images of the frames up to the frame of the coordinate position of (M, N) are picked up. The image of each frame has an overlapping portion or portions of a predetermined number of pixels with an image or images of an adjacent frame or frames. In this manner, the camera unit produces still images by successively varying the image pickup direction thereof.

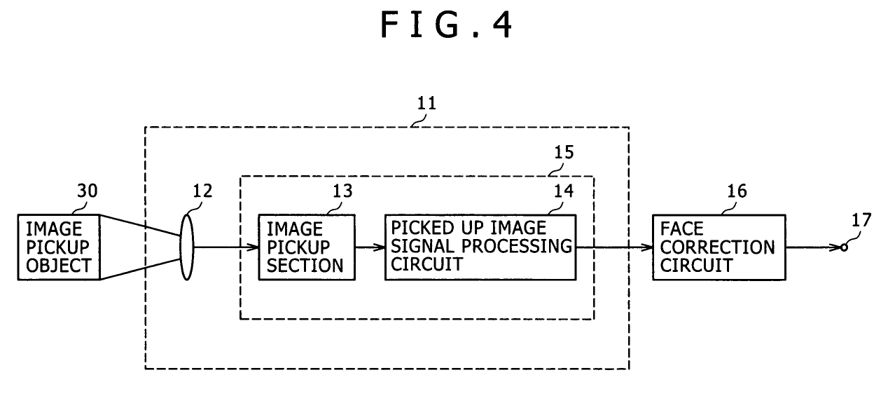

FIG. 4 shows a configuration of the infrared camera 11 and the face correction circuit 16. The infrared camera 11 outputs image data of a picked up image obtained by image pickup of an image pickup object 30 to the face correction circuit 16. The infrared camera 11 includes a lens 12, an image pickup section 13 and a picked up image signal processing circuit 14. The lens 12 condenses infrared rays emitted from the image pickup object 30 and introduces the condensed infrared rays into the image pickup section 13. The image pickup section 13 includes an infrared detector, an amplifier and so forth and produces an analog signal corresponding to an amount of energy of the detected infrared rays.

The picked up image signal processing circuit 14 includes an A/D conversion circuit, an infrared image processing section and so forth, and coverts an analog signal inputted thereto from the image pickup section 13 into a digital signal and outputs the digital signal. The infrared image processing section receives the digital signal and converts the digital signal into monochromatic image data whose whiteness increases as the energy of the infrared rays rises, that is, as the temperature rises. Then, the image data which may be, for example, a digital color video signal similar to that of the NTSC system are outputted to the face correction circuit 16.

FIG. 5 shows an example of the face correction circuit 16. Referring to FIG. 5, the face correction circuit 16 shown includes a face average value calculation circuit 31, a correction value memory 33, an image pickup state correction circuit 34, and subtraction circuits 32 and 35. The correction value memory 33 is a nonvolatile memory such as a flash memory.

Upon face correction, a correction value unique to the infrared camera 11 is produced first and is stored into the correction value memory 33. In FIG. 5, a flow of a signal upon correction value production is indicated by a thick line. Upon correction value production, a uniform face jig with which, when an image of the image pickup object 30 is picked up by an ideal infrared camera which does not provide irregularity in brightness, a picked up image having a fixed pixel value, that is, a fixed luminance level, over all of the pixels, is used as the image pickup object 30. In particular, a plate of a material with which thermal irregularity is less likely to occur such as, for example, a plate of foamed polystyrol, is used. In the case of a metal plate, thermal irregularity is likely to occur, and therefore, the metal plate is not suitable for a reference image pickup face. An image of this uniform face jig is picked up by the infrared camera 11. An image pickup circuit 15 of the infrared camera 11 outputs image data of the picked up image to the face correction circuit 16.

The face correction circuit 16 calculates a face average value which is an average value of the pixel value among all pixels of the inputted image data from the pixel values of the pixels of the image data. Then, from the pixel value of each pixel and the face average value, a correction value of the pixel is calculated and stored into the correction value memory 33.

31 After such correction value production as described above is carried out, normal image pickup is carried out. In FIG. 5, a flow of a signal upon ordinary image pickup is indicated by a solid line. Upon normal image pickup, image data of a picked up image picked up by the infrared camera 11 is inputted to the face correction circuit 16. The pixel values of the image data inputted to the face correction circuit 16 are corrected using the pixel correction values stored upon camera setting, and the resulting corrected pixel values are outputted.

In the following, the components of the face correction circuit 16 are described.

The face average value calculation circuit 31 calculates a face average value which is an average value of the pixel value of image data inputted from the image pickup circuit 15 among all pixels of one still image and outputs the calculated face average value to the subtraction circuit 32. The face average value Vref is calculated from image data of an m×n pixel size in accordance with the following expression (1):

face average value

$$face average value Vref = ( {\sum }_{0 , 0}^{( m - 1 ) , ( n - 1 )} pixel level ( x , y ) ) / ( m \times n )$$

pixel level (x, y))/(m×n)

The subtraction circuit 32 subtracts the face average value inputted from the face average value calculation circuit 31 from the pixel value of the image data inputted from the image pickup circuit 15 to produce a correction value. Then, the subtraction circuit 32 stores the correction value produced for each pixel into the correction value memory 33. The pixel correction value ΔV(x, y) of the pixel at the (x, y)th position is calculated in accordance with the following expression (2):

pixel correction value ΔV(x, y)=pixel level(x, y)−face average value

The correction value memory 33 is formed from a flash memory or the like and stores the pixel correction values calculated upon camera setting. Then, upon normal image pickup, a pixel correction value stored in the correction value memory 33 is read out and used for correction.

The image pickup state correction circuit 34 outputs a correction value obtained by multiplying the correction value read out from the correction value memory 33 by a necessary coefficient to the subtraction circuit 35. Such a correction value as just mentioned is to correct, when image pickup is to be carried out in an image pickup state different from that upon correction value production, a pixel correction value stored in the correction value memory 33 in response to the image pickup state then thereby to prevent malfunction in correction operation caused by the difference of the image pickup condition. The coefficient is set, for example, in response to the gain, contrast, lens aperture and so forth of the infrared camera 11.

It is to be noted that setting of the gain, contrast, lens aperture and so forth is carried out by the control apparatus 24 which controls the infrared camera 11, face correction circuit 16 and so forth. Such setting is carried out in various manners on a GUI (Graphical User Interface) displayed on the display section of the control apparatus 24.

The subtraction circuit 35 subtracts the correction value of each pixel inputted from the image pickup state correction circuit 34 from the value of the pixel of the image data inputted from the image pickup circuit 15, so that the subtraction circuit 35 obtains the pixel values after correction.

The image data after correction are outputted from the subtraction circuit 35 to an output terminal 17. The image data obtained at the output terminal 17 have no irregularity in brightness such as shading originating from the infrared camera 11. Therefore, also on a whole image of a wide field of view including a plurality of picked up images connected to each other, irregularity in brightness is suppressed. Consequently, a uniform image can be obtained.

It is to be noted that, in the embodiment of the present invention, the face correction circuit 16 is provided at the stage next to the infrared camera 11 such that image data outputted from the infrared camera 11 are corrected by the face correction circuit 16. However, the face correction circuit 16 may otherwise be connected to the stage next to the picked up image signal processing circuit 14 of the infrared camera 11.

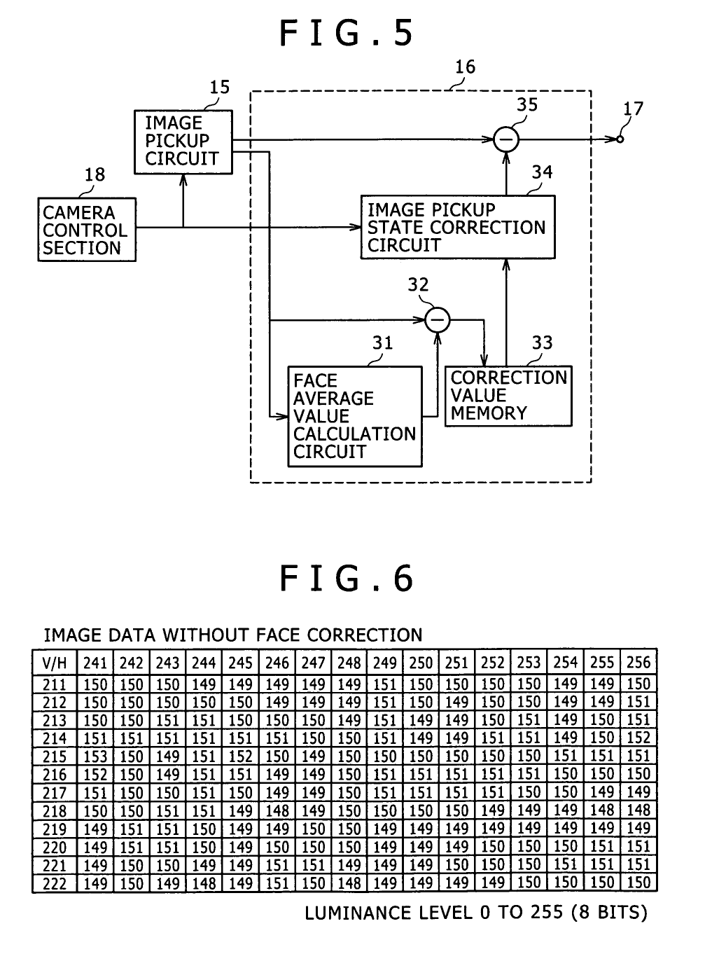

In the following, the correction process according to the embodiment of the present invention is described in detail with reference to FIGS. 6 to 8. FIG. 6 illustrates part of image data of a picked up image of the 640×480 size inputted from the image pickup circuit to the face correction circuit. In particular, FIG. 6 illustrates a partial image in a region of a range of vertical addresses 211 to 222 and a range of horizontal addresses 241 to 256. It is to be noted that, in the present example, the vertical address ranges from 0 to 479 and the horizontal address ranges from 0 to 639. A pixel value is data of, for example, 8 bits and has a value in a range from 0 to 255. The image data illustrated in FIG. 6 are image data of a picked up image obtained by picking up a uniform face jig having uniform luminance by means of the infrared camera 11.

First, a face average value of the image data is calculated. The face average value is calculated in the following manner using the expression (1).

face average value Vref=(Y(241, 211)+Y(242, 211)+ . . . + Y(255, 222)+Y(256, 222)/(16×12)=149.9166667≈150

where Y(x, y) represents the pixel value of the pixel which is the xth pixel in the horizontal direction and is the yth pixel in the vertical direction.

Then, the pixel correction value for each pixel is calculated. The pixel correction value is obtained by subtracting the face average value described above from the value of each pixel illustrated in FIG. 6. For example, since the luminance value Y(244, 211) of the pixel (244, 411) is 149, the pixel correction value is calculated in the following manner in accordance with the expression (2):

pixel correction value ΔV(244, 211)=149−150=−1

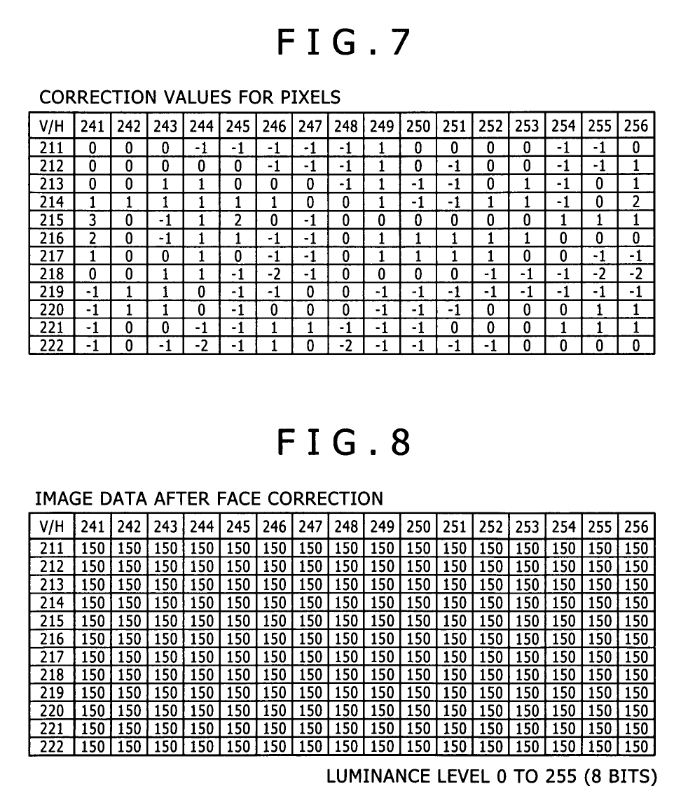

Similarly, also with regard to each of the other pixels, the pixel correction value ΔV is calculated. FIG. 7 illustrates the pixel correction values ΔV calculated in this manner for the individual pixels.

The resulting pixel correction values are stored into the correction value memory 33. Then, upon normal image pickup, if image data are inputted from the infrared camera 11, then the pixel correction values are read out and the pixel values of the pixels of the inputted image data are corrected with the individual pixel correction values.

For example, the image data illustrated in FIG. 6 are corrected. In this instance, the luminance values of the pixels after the correction are obtained by subtracting pixel correction values of the pixels illustrated in FIG. 7 from the luminance values of the pixels illustrated in FIG. 6. For example, since the luminance value Y(244, 211) of the pixel (244, 211) is 149 and the pixel correction value ΔV(244, 211) is −1, the luminance value Y′ after the correction can be calculated in the following manner:

luminance value Y′ after correction=149−(−1)=150

Also with regard to each of the other pixels, the luminance value Y′ after the correction can be calculated in a similar manner.

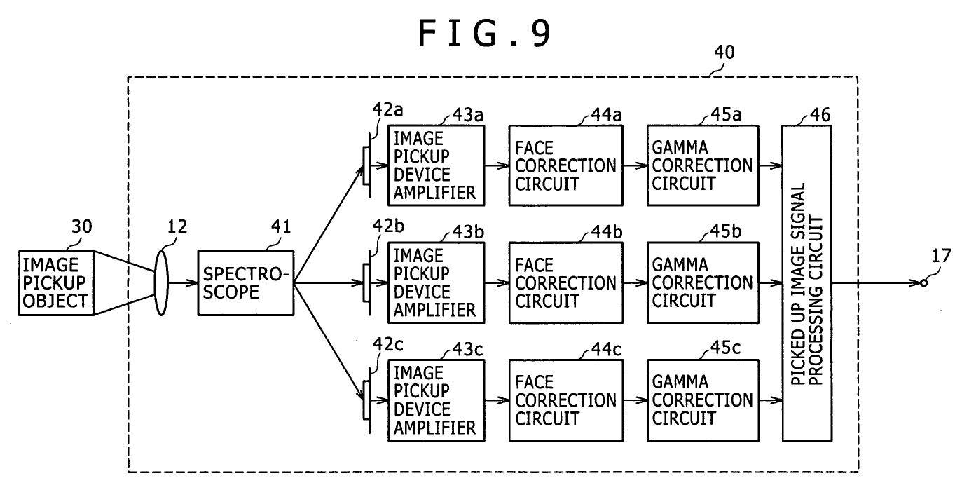

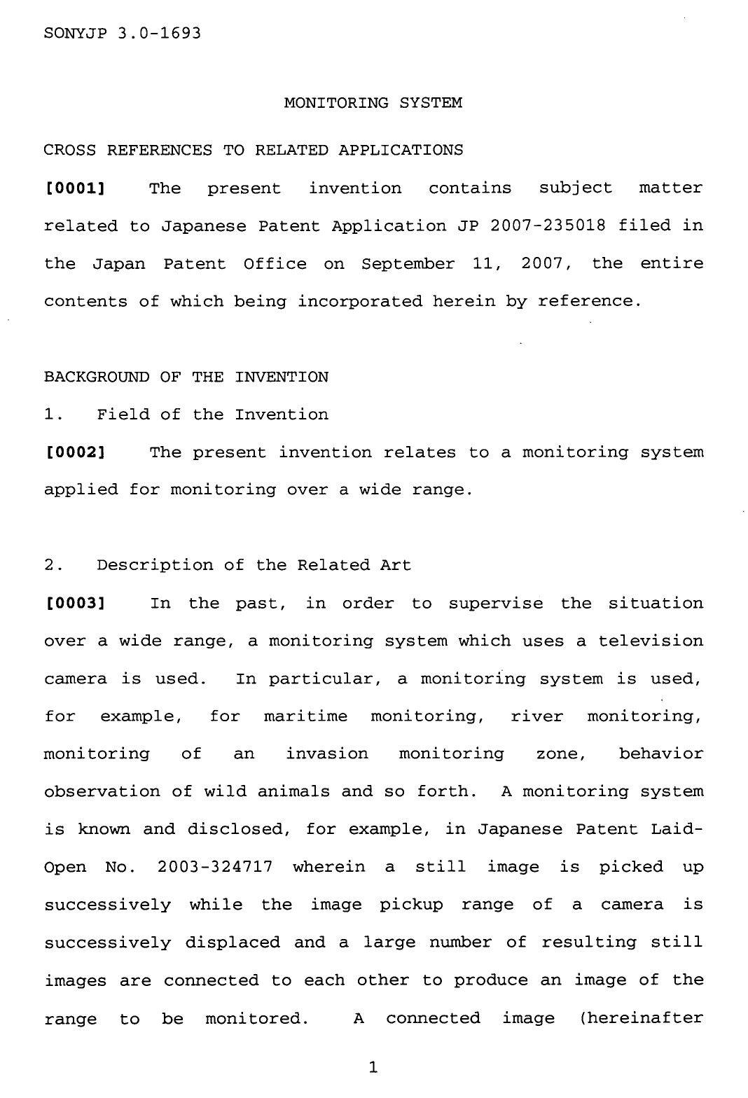

FIG. 8 illustrates the luminance values Y′ of the picked up image of the 16×12 size after the correction. It can be seen in FIG. 8 that, with the image data illustrated, the luminance values Y′ of all of the pixels are 150, and image data having uniform luminance are obtained.

As seen in FIG. 8, a picked up image of uniform brightness can be obtained. Further, where a plurality of such picked up images are combined to obtain a whole image of a wide field of view, shading at a boundary portion between adjacent picked up images does not stand out, and screen image irregularity little occurs.

Meanwhile, as seen in FIG. 9, a 3-CCD color camera 40 which includes a processing circuit for exclusive use, a calculation circuit and so forth for a unique input to each of the three primary colors includes face correction circuits 44a to 44c provided for processing systems for the individual colors.

With the configuration shown in FIG. 9, an incoming light beam is decomposed into three primary color light beams by a spectroscope 41, and the three primary color light beams are introduced into and converted into electric signals by image pickup devices 42a, 42b and 42c which may each be a CCD device. Further, output signals of the image pickup devices 42a, 42b and 42c are supplied to the face correction circuits 44a, 44b and 44c through amplifiers 43a, 43b and 43c, respectively. The face correction circuits 44a, 44b and 44c have a configuration similar to that of the face correction circuit 16 described hereinabove for the color signals of red, green and blue and correct irregularity of the level of the color signals.

Output signals of the face correction circuits 44a, 44b and 44c are supplied to a picked up image signal processing circuit 46 through gamma correction circuits 45a, 45b and 45c, respectively. The picked up image signal processing circuit 46 carries out A/D conversion, matrix processing and so forth, and, for example, a composite color video signal is extracted from the output terminal 17. In this manner, by applying the embodiment of the present invention to the color video camera for image pickup in the daytime, irregularity in brightness and color is corrected, and a whole image obtained by connecting color still images can be formed in good quality.

While preferred embodiments of the present invention have been described using specific terms, such description is for illustrative purpose, and it is to be understood that changes and variations may be made without departing from the spirit or scope of the following claims.

It should be understood by those skilled in the art that various modifications, combinations, sub-combinations and alterations may occur depending on design requirements and other factor in so far as they are within the scope of the appended claims or the equivalents thereof.

What is claimed is:

1. A monitoring system, comprising:
an infrared camera;
image pickup direction control means for varying the image pickup direction of said infrared camera;
correction means for correcting irregularity in brightness of a screen image of image data picked up in each of the image pickup directions by said infrared camera and outputting the corrected image data whose irregularity in brightness is corrected;
image processing means for connecting the corrected image data corresponding to the image data picked upon in the individual image pickup directions by said infrared camera to produce a whole image; and
display means for displaying the whole image;
said correction means including
correction value storage means for storing correction values corresponding to the pixels of the image data, and
subtraction means for subtracting the correction values read out from said correction value storage means from the pixel values of the pixels of the image data to obtain correction image data and outputting the correction image data.

2. The monitoring system according to claim 1, wherein the correction values are an average value of image data obtained by picking up a uniform image pickup object by means of said infrared camera and differences between the pixel values of the image data and the average value.

3. The monitoring system according to claim 1, wherein said correction means includes image pickup state correction means for changing the correction values in response to an image pickup condition of said infrared camera.

4. A monitoring system, comprising:
a video camera;
image pickup direction control means for varying the image pickup direction of said video camera;
correction means for correcting irregularity in brightness of a screen image of image data picked up in each of the image pickup directions by said video camera and outputting the corrected image data whose irregularity in brightness is corrected;
image processing means for connecting the corrected image data corresponding to the image data picked upon in the individual image pickup directions by said video camera to produce a whole image; and
display means for displaying the whole image;
said correction means including
correction value storage means for storing correction values corresponding to the pixels of the image data, and
subtraction means for subtracting the correction values read out from said correction value storage means from the pixel values of the pixels of the image data to obtain correction image data and outputting the correction image data.

5. The monitoring system according to claim 4, wherein the correction values are an average value of image data obtained by picking up a uniform image pickup object by means of said video camera and differences between the pixel values of the image data and the average value.

6. The monitoring system according to claim 4, wherein said video camera includes a plurality of image pickup devices, to each of which said correction means is connected, and the correction means individually form corrected image data whose irregularity in brightness and color is corrected.
